(19) United States
(12) Patent Application Publication
(10) Pub. No.: US 2004/0080545 A1
(43) Pub. Date: Apr. 29, 2004

(54) Method for dynamic accessibility of a drop-down selection in a GUI combobox construct

(75) Inventors: Jeffrey S. Kobal, Lake Worth, FL (US); James R. Lewis, Delray Beach, FL (US); L. Clarence Nethery JR., Lake Worth, FL (US)

Correspondence Address: Gregory A. Nelson, Akerman Senterfitt, 222 Lakeview Avenue, Fourth Floor, P.O. Box 3188, Palm Beach, FL, 33402-3188, US

(73) Assignee: International Business Machines Corporation, Armonk, NY (US)

(21) Appl. No.: 10/281,529

(22) Filed: Oct. 28, 2002

(51) Int. Cl. G09G 5/00

(52) U.S. Cl. 345/824; 345/825

(57) ABSTRACT

A method and a machine-readable storage for operation of a combobox in a graphical user interface (GUI). Conditions are defined which indicate an accessibility of items for presentation in a listbox associated with the combobox and particular ones of the conditions are associated with the combobox. The associated conditions are consulted to dynamically determine the accessibility of the items for the listbox during operation of a program. Further, if items are inaccessible for the listbox, the inaccessibility of the listbox is automatically visually indicated in accordance with the consulting step.

### BACKGROUND OF THE INVENTION

1. Technical Field

This invention relates to the field of graphical user interfaces (GUI's) and, more particularly, to interactive constructs.

2. Description of the Related Art

The advent of GUI applications has spurred the development of a variety of GUI constructs. A common GUI construct that is well known in the art of GUI application development is a “combobox.” A combobox is a data entry construct that is often used to facilitate user interaction with a computer application. From a combobox, a user can enter data or information, select an entry from a list of possible responses, initiate an action, and issue other computer commands. A combobox typically includes an edit control, which is used to collect and display textual and numeric data, and a listbox, which is used to display a list of selectable options to a user. The listbox is usually presented in the form of a drop-down menu such that the list is hidden from view until activated, and requires the user to click on a drop-down button to display the list. After an option is selected the list then disappears.

In some applications, the contents of the listbox are dynamically determined. For example, the listbox can be populated with selectable options that are dependent upon various conditions, such as a previous user selection, an available inventory, available order options, and so on. In some instances, the listbox can be empty. For example, a combobox can be used on an order form to allow users to select available options for merchandise being ordered, such as color or size. But some of the merchandise may not have available options, such as a handbag that is only available in one color and in one size. In such a case, it is not user-friendly to require a user to activate the listbox when the list is empty. Not only is a user's time wasted in activating the listbox, but a user may be led to believe that selectable options are available and that there is a problem with the order form.

### SUMMARY OF THE INVENTION

The invention disclosed herein provides a method and a machine-readable storage for enhancing operation of a combobox in a graphical user interface (GUI). The method and machine-readable storage indicate whether a listbox associated with a combobox is accessible. Accordingly, a user will not needlessly waste time manually activating, or attempting to activate, a listbox associated with the combobox only to find that the listbox is empty or otherwise unavailable.

In one arrangement, a cue can be provided to indicate listbox accessibility. For example, conditions can be established to determine if a list of selectable options is available for the combobox, whether the user has privileges to access the listbox, whether further user input is required prior to the user having access to the listbox, indicate the operating state of an application, or any other condition relating to the combobox that can be identified to the user via a cue. These conditions then can be associated with particular comboboxes and consulted when providing the cue. For example, the inaccessibility of items can be visually indicated by changing an appearance of the combobox, such as changing a color of the combobox, or changing an appearance of an element of the combobox, for example changing the color of a drop-down button associated with the combobox.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a schematic diagram illustrating an exemplary system for indicating an accessibility of items in a listbox associated with a combobox in accordance with the inventive arrangements disclosed herein.

FIG. 2 is a flow chart illustrating a method for establishing conditions which indicate an accessibility of items in a listbox associated with a combobox according to the inventive arrangements disclosed herein.

FIG. 3 is a flow chart illustrating a method for evaluating conditions to determine an accessibility of items in a listbox associated with a combobox according to the inventive arrangements disclosed herein.

FIGS. 4A-4D are schematic diagrams illustrating an exemplary graphical user interface (GUI) comprising a plurality of comboboxes wherein the accessibility of a listbox associated with a combobox is indicated in accordance with the inventive arrangements disclosed herein.

### DETAILED DESCRIPTION OF THE INVENTION

The invention disclosed herein provides a method and a machine-readable storage for enhancing operation of a combobox in a graphical user interface (GUI). The present invention provides a method for indicating an accessibility of a listbox associated with a combobox. In particular, a user interfacing with a computer application is provided a cue indicating the status of the listbox. For example, the cue can indicate whether there is a list of selectable options available for the listbox, whether the user has privileges to access the listbox, whether further user input is required prior to the user having access to the listbox, an operating state of an application, or any other condition relating to the combobox that can be identified to the user via a cue. Accordingly, the user need not waste time manually activating, or attempting to activate, a listbox of selectable options associated with the combobox only to find that the listbox is empty or otherwise unavailable.

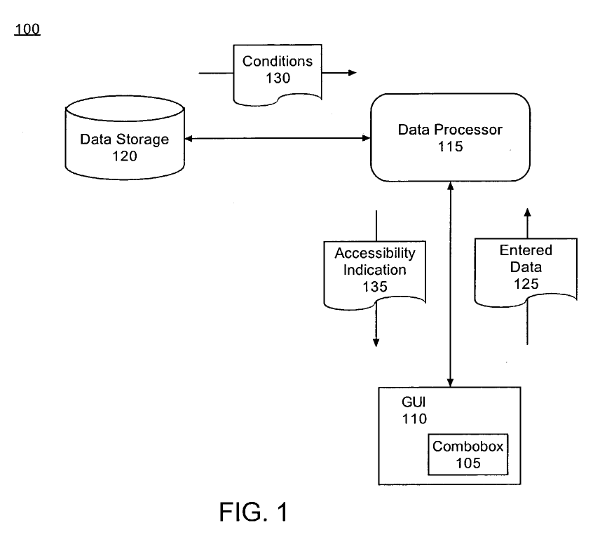

As shown in FIG. 1, a schematic diagram is depicted which illustrates an exemplary system 100 for indicating an accessibility of items in a combobox 105. The combobox 105 can be contained in a graphical user interface (GUI) 110 and used to present user selectable options. For example, a listbox can be associated with the combobox 105 to display a list of possible user responses, actions, and other computer commands available to a user. Further, other GUI constructs can be incorporated into the GUI 110 as well, for example, textual and numerical data entry controls, radio buttons, object navigation buttons, text boxes, and other GUI constructs known to the skilled artisan. The system 100 also can include a data processor 115 and a data storage 120. The data processor 115 can be, for example, an application program, a plug-in for an application, an application module, or any other data processing object.

In operation, entered data 125, for example data entered into a data entry control in the GUI 110, can be processed by the data processor 115. The data processor 115 can evaluate the entered data 125 based on pre-determined conditions 130 retrieved from the data storage 120, and generate an accessibility indication 135 for the combobox 105. The accessibility indication 135 is used by the system to indicate to the user whether the user should access the combobox 105 or a listbox associated with the combobox 105. For example, the accessibility indication 135 can be a visual cue applied to the combobox 105, a lock applied to the combobox 105, a color change applied to a drop-down button associated with the combobox 105, or any other indication that the user need not waste time accessing the combobox 105 or the listbox associated with the combobox 105.

The combobox 105 also can be implemented as a unified GUI construct wherein predetermined logic is automatically associated with the combobox. In particular, the predetermined logic can control the operation of the combobox and features associated with the combobox. For example, when a programmer provides a combobox in a computer application, program code for generating an accessibility indication for the combobox or a list box associated with the combobox can be automatically provided in the application program code.

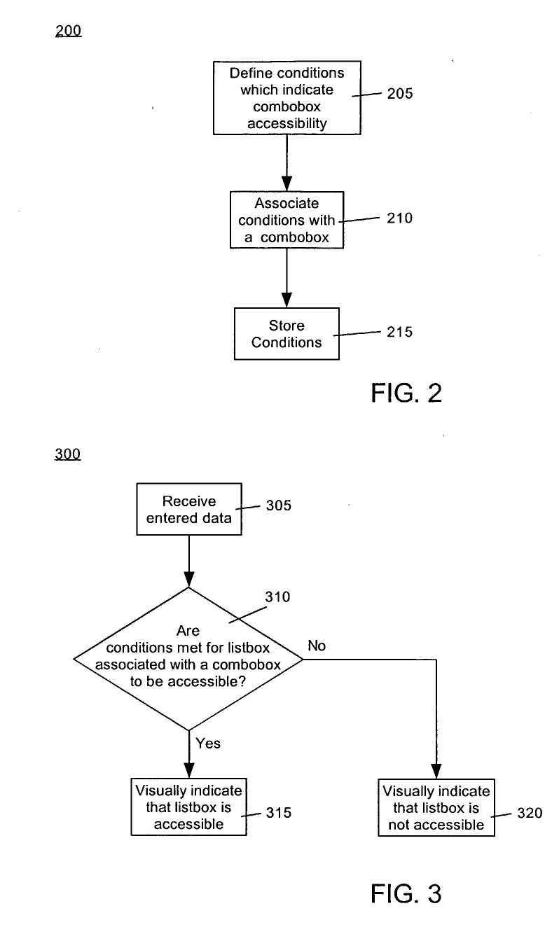

Referring to FIG. 2, a flow chart 200 is presented which illustrates a method of establishing pre-determined conditions which can be associated with comboboxes. At step 205, conditions are defined which indicate the accessibility of combobox items. The conditions can evaluate whether there is an empty item list (listbox) associated with entered data, a condition associated with a user not having privileges to access a listbox associated with a combobox, a condition associated with a requirement for further user input prior to the user having access to the listbox, or any other condition that can be applied to entered data and used to determine combobox or listbox accessibility.

For example, a GUI order form can be presented to a user wherein the user can enter a merchandise selection into a data entry field. If that merchandise selection is an article of clothing, it would be appropriate to display comboboxes with listboxes from which the user can select available options for the clothing, such as color and size. However, if the selected merchandise is an umbrella which is available only in one color and in one size, it would not be user friendly to display comboboxes for color and size selection without an indication that the user need not activate the listboxes associated with the comboboxes. Without such indication, a user may be led to falsely believe that a variety of colors and sizes are available for the umbrella. Moreover, the user may waste time and effort selecting listboxes that are either empty or only contain one default item.

A condition also can be associated with, and dependent upon, an operational state of a program. For example, if it is proper for particular steps to be performed prior to a selection being made in a specific combobox, a cue can be provided indicating that the program is not ready for that specific combobox, or an associated listbox, to be accessed. Moreover, in the case that contents of a particular listbox are dynamic, cues can be provided to indicate the nature of selections that are currently available in the listbox or the quantity of selections available. Importantly, many other types of conditions relating to the accessibility of comboboxes and listboxes can be established, as would be known by those skilled in the art, and such conditions are intended to be within the scope of the present invention.

Referring to step 210, each condition that is generated can be associated with a combobox. Alternatively, particular conditions can be associated with a plurality of comboboxes. For example, a condition which queries a database to determine if particular selectable options are available can be associated with two or more comboboxes. At step 215, conditions that are generated can be stored, for example in the data storage.

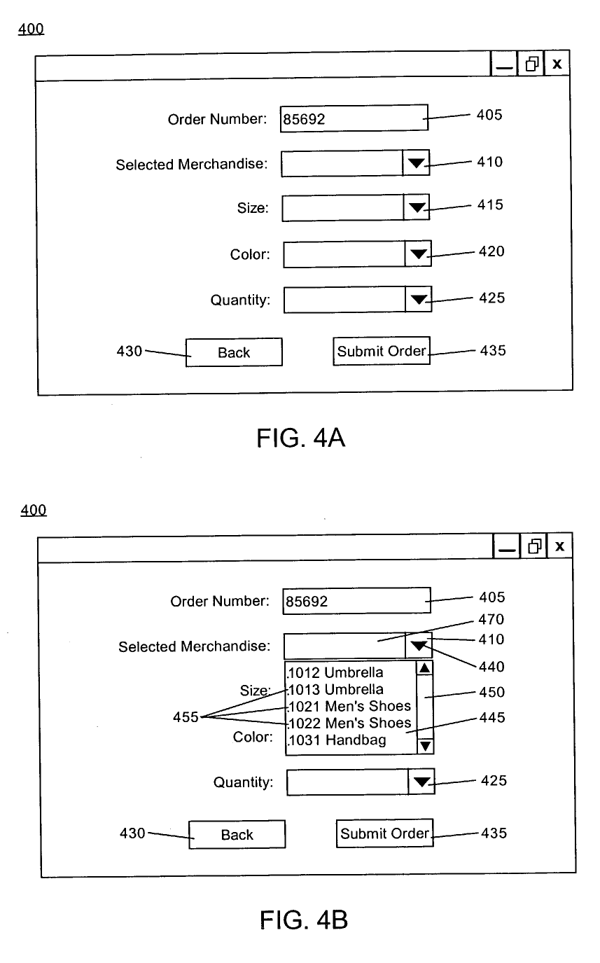

FIG. 3 is a flow chart illustrating a method of evaluating conditions to determine accessibility of a listbox associated with a combobox. At step 305, the data processor can receive entered data, for example data entered by a user into a data entry control of a GUI. Referring to decision box 310, the data processor can evaluate the entered data using the pre-defined conditions to determine whether a particular listbox associated with the combobox should be user accessible. For example, the data processor can evaluate whether there are a plurality of selectable items available to display in the listbox. If the conditions are met for a particular listbox to be user accessible, the data processor can provide an accessibility indication to the GUI to visually indicate the listbox is accessible, as shown in step 315. For example, the combobox can be presented in a typical combobox form as would be known to the skilled artisan.

However, if the conditions are not met for the listbox associated with the combobox to be user accessible, the data processor can provide an accessibility indication to the GUI to visually indicate that the listbox is not accessible, as shown in step 320. For example, the appearance of the combobox can be changed. In one arrangement, the combobox can be presented in a color, such as gray or red, that is different than accessible GUI constructs. In a further example, the combobox can be hidden or faded from view. In yet another example, a drop-down button associated with the combobox can be presented in an alternate color, faded, hidden from view, or locked so as not to be activatable. A combination of indicators also can be provided, for example, the combobox can be presented in an alternate color and the listbox can be locked so as not to be activatable. Still, there are many other ways recognizable by those skilled in the art in which accessibility and non-accessibility of a combobox or a listbox associated with the combobox can be indicated, and such methods are intended to be within the scope of the present invention.

Further, a default listbox accessibility indicator can be provided with a combobox and a selectable list of indicators can be provided to allow the default indicator to be changed by a user. For example, an indicator which fades the drop-down button from view can be provided as a default accessibility indicator. Various options for changing the appearance of the combobox also can be provided to enable a user to change a particular listbox accessibility indicator from the default indicator. For example, the user can change the accessibility indicator from an indicator which fades the drop-down button to an indicator which presents the drop-down button as being gray in color.

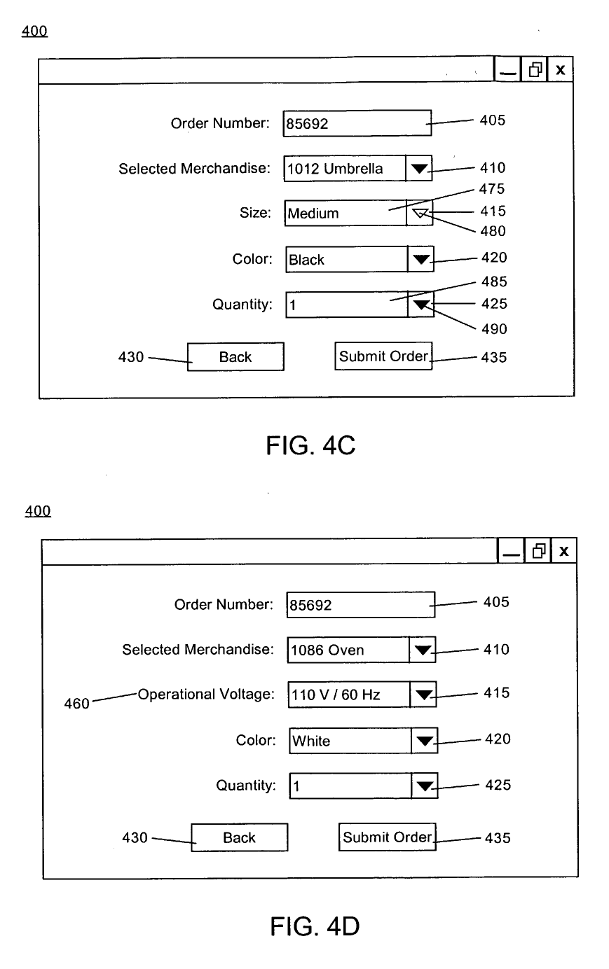

FIG. 4A is a schematic diagram illustrating an exemplary GUI 400 comprising a plurality of comboboxes 410, 415, 420, 425. Further, additional GUI constructs can be provided as well, for example a data entry control 405 and control buttons 430 and 435. In this example, an order number can be entered into the data entry control 405, for example by a user or by an automatic process operating within the data processor.

Referring to FIG. 4B, a user can choose to select an object using combobox 410, for example to select a piece of merchandise. To begin the object selection process, the user can select drop-down button 440, which activates a listbox 445 (which is also commonly referred to as a drop-down menu). The listbox 445 can present to the user a list of selectable options 455 from which the user can choose. Further, the listbox 445 can include a scrollbar 450 which can be used by the user to scroll through the list of selectable options 455, in this case, a list of available merchandise. When the user selects an object from the listbox 445, the object can be displayed in an edit control 470 associated with the combobox 410, as shown in FIG. 4C.

In this example, the user has selected an umbrella that only comes in one size. Thus, it would not be efficient for the user to activate combobox 415 only to find one size is available. Hence, a visual cue associated with the combobox 415 can be presented to alert the user that there is not a list of selectable options available from combobox 415, as previously discussed. For example, a drop-down button 480 can be faded as shown, changed in color, or completely hidden from view, i.e. removed from GUI 400. Further, the one size that is available for the umbrella can be automatically displayed in the edit control 475 and an indicator that this is the only available size can be provided.

An object being purchased, such as the umbrella, may be available in a variety of colors, however. Accordingly, combobox 420 can be presented in a standard format to alert the user that a selection of color options is available. Further, combobox 425 can be presented in a standard format to enable the user to select a quantity for the purchase. In another arrangement, a user can manually type an entry into edit control 485, for example the desired purchase quantity. If manual entry of purchase quantity is required, the appearance of drop-down button 490 can be changed to signify such requirement.

In another arrangement, as shown in FIG. 4D, the combobox can be dynamically activated and deactivated to present only pertinent selectable options. For example, if a user selects an oven, the oven may be available for different supply voltages, but not in different sizes. Accordingly, combobox identifier 460 can be dynamically selected to represent the available options available in a listbox associated with the combobox 415.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. In a graphical user interface (GUI), a method for operation of a combobox comprising the steps:
defining conditions which indicate an accessibility of items for presentation in a listbox associated with the combobox;
associating particular ones of the conditions with the combobox;
consulting the associated conditions to dynamically determine the accessibility of the items for the listbox during operation of a program; and
if items are inaccessible for the listbox, automatically visually indicating the inaccessibility of the listbox in accordance with said consulting step.

2. The method of claim 1, wherein the defined conditions are selected from the group consisting of a condition associated with an empty item list, a condition associated with a user not having privileges to access an item list, a condition associated with a requirement for further user input prior to a user having access to an item list, and an operating state of an application.

3. The method of claim 1, wherein said step of visually indicating the inaccessibility of items further comprises the step of changing an appearance of a drop-down button associated with the combobox.

4. The method of claim 4, wherein said step of changing the appearance of the drop-down button associated with the combobox comprises changing a color of the drop-down button.

5. The method of claim 1, wherein said step of visually indicating the inaccessibility of items further comprises the step of changing an appearance of the combobox.

6. The method of claim 5, wherein said step of changing the appearance of the combobox comprises changing a color of the combobox.

7. The method of claim 5, wherein said step of changing the appearance of the combobox comprises the step of changing an appearance of an element of the combobox.

8. The method of claim 1, further comprising the step of automatically populating an edit control of a combobox with a selectable option when only one selectable option is available for the combobox.

9. A machine-readable storage, having stored thereon a computer program having a plurality of code sections executable by a machine for causing the machine to perform the steps of:
defining conditions which indicate an accessibility of items for presentation in a listbox associated with the combobox;
associating particular ones of the conditions with the combobox;
consulting the associated conditions to dynamically determine the accessibility of the items for the listbox during operation of a program; and
if items are inaccessible for the listbox, automatically visually indicating the inaccessibility of the listbox in accordance with said consulting step.

10. The machine-readable storage of claim 9, wherein the defined conditions are selected from the group consisting of a condition associated with an empty item list, a condition associated with a user not having privileges to access an item list, a condition associated with a requirement for further user input prior to a user having access to an item list, and an operating state of an application.

11. The machine-readable storage of claim 9, wherein said step of visually indicating the inaccessibility of items further comprises the step of changing an appearance of a drop-down button associated with the combobox.

12. The machine-readable storage of claim 9, wherein said step of visually indicating the inaccessibility of items further comprises the step of changing an appearance of the combobox.

13. The machine-readable storage of claim 9, wherein said step of changing the appearance of the drop-down button associated with the combobox comprises changing a color of the drop-down button.

14. The machine-readable storage of claim 9, wherein said step of visually indicating the inaccessibility of items further comprises the step of changing an appearance of the combobox.

15. The machine-readable storage of claim 9, wherein said step of changing the appearance of the combobox comprises changing a color of the combobox.

16. The machine-readable storage of claim 9, further comprising the step of automatically populating an edit control of a combobox with a selectable option when only one selectable option is available for the combobox.

17. A combobox GUI component having logic for dynamically enabling and disabling a listbox associated with a combobox and visually changing an appearance of an element of the combobox to indicate availability of selectable items within the listbox.
